(19) United States
(12) Patent Application Publication
(10) Pub. No.: US 2007/0185836 A1
(43) Pub. Date: Aug. 9, 2007

(54) Method for caching faceted search results

(76) Inventors: John H. Handy-Bosma, Cedar Park, TX (US); Sarvar N. Khosravi, Louisville, CO (US); Eric A. Klein, Dallas, TX (US); Joanna W. Ng, Unionville (CA); John F. Palmer, Sommers, NY (US); Mei Y. Selvage, Pocatello, ID (US)

Correspondence Address: IBM CORP. (CLG);c/o CARDINAL LAW GROUP, 1603 ORRINGTON AVENUE, SUITE 2000, EVANSTON, IL, 60201, US

(21) Appl. No.: 11/351,061

(22) Filed: Feb. 9, 2006

(51) Int. Cl. G06F 17/30

(52) U.S. Cl. 707/3

(57) ABSTRACT

A method of caching faceted search results includes providing a rule set and receiving system criteria. The method further includes generating at least one faceted search result based on a first faceted search using a plurality of search terms, and maintaining at least a portion of the faceted search results in a denormalized database based on the rule set and system criteria. A computer readable medium including computer readable code for executing the method steps, as well as a system including means for executing the method steps is also disclosed.

### FIELD OF INVENTION

The present invention generally relates to faceted searching. More specifically, the invention relates to caching faceted search results.

### BACKGROUND OF THE INVENTION

Faceted search engines challenge system designers based on performance and scalability issues based on the large number of facet calculations to be executed at runtime. The number of operations can quickly increase beyond the capacity of most systems, even for simple sets of content. Facet logic involves a very large number of set intersections that must be performed for each facet count to be presented in a user interface or invoked by other program logic. If an application has a large amount of content and a fully developed facet structure with many facets, the system demands present a significant design challenge.

FIG. 1A illustrates exemplary faceted search results. As shown, a search for the search terms “any tern” returns 7641 matches, or set intersections. The results are displayed on a graphical display that provides for further searches to filter the results according to sector, client set, or location in this example.

A solution that reduces the system demands for faceted searching would improve the prior art One potential solution is to store repeated faceted set intersections, including those that can be a part of subsequent queries against the faceted search engine so that previous faceted search results can be returned to the user interface without re-execution of the faceted search calculations against the data store. However, even with an optimal degree of denormalization, a faceted search of a several million document store, a not uncommon size, with only 20 top-level facet calculations, results in many millions of positions. Storage of such faceted search results quickly strains storage solutions.

Similarly, the storage problems presented by storing faceted search results has been a barrier to presentation of large collections of content with faceted views, as well as a barrier to adoption of semantic technologies such as auto-characterization of large content collections. It then follows that these storage problems have hampered adoption of business intelligence and data mining for faceted data collections.

A denormalized facet relational index is a particular kind of inverted index that features denormalized facet structures in inverted index term lists. Each document or data record ID in a descendant term list is populated up ancestor nodes to the root of a facet. Typical facet relation indices are constructed from a set of defining hierarchical and semantic structures in one or more XML representations and a set of documents or data records tagged to the semantic and hierarchical structures. Exemplary XML representations include RAS, OWL, OIL+, DAML, RDF, RDF-S, and well-formed XML.

To allow for fast calculation of set intersections among arbitrary facet elements, a facet relational index denomalis or copies all ID's contained in a term list from descendants to the root. Therefore a calculation of set intersections iterates over a reduced number of ID's instead of looking down facet trees only to hit the same ID's repeatedly. Although the calculation iterates over fewer ID's, the required storage space grows rapidly with the number of set intersections.

It is desirable therefore to overcome these disadvantages of the prior art.

### SUMMARY OF THE INVENTION

A method of caching faceted search results includes providing a rule set and receiving system criteria. The method further includes generating at least one faceted search result based on a first faceted search using a plurality of search terms, and maintaining at least a portion of the faceted search results in a denormalized database based on the rule set and system criteria.

A computer usable medium including computer readable code for caching faceted search results includes computer readable code for providing a rule set and computer readable code for receiving system criteria. The medium further includes computer readable code for generating at least one faceted search result based on a first faceted search using a plurality of search terms, and computer readable code for maintaining at least a portion of the faceted search results in a denormalized database based on the rule set and system criteria.

A system for caching faceted search results includes means for providing a rule set and computer readable code for receiving system criteria. The system further includes means for generating at least one faceted search result based on a first faceted search using a plurality of search terms, and means for maintaining at least a portion of the faceted search results in a denormalized database based on the rule set and system criteria

The foregoing embodiment and other embodiments, objects, and aspects as well as features and advantages of the present invention will become further apparent from the following detailed description of various embodiments of the present invention. The detailed description and drawings are merely illustrative of the present invention, rather than limiting the scope of the present invention being defined by the appended claims and equivalents thereof.

### BRIEF DESCRIPTION OF THE DRAWINGS

FIG. 1A illustrates exemplary faceted search results presented on a graphical display;

FIG. 1B illustrates one embodiment of a computer client, in accordance with one aspect of the invention;

FIG. 2 illustrates one embodiment of a network system for use in accordance with one aspect of the invention;

FIG. 3 illustrates an embodiment of a method for caching faceted search results, in accordance with one aspect of the invention;

FIG. 4 illustrates an embodiment of a method for caching faceted search results, in accordance with one aspect of the invention;

FIG. 5 illustrates an embodiment of a method for caching faceted search results, in accordance with one aspect of the invention;

### DETAILED DESCRIPTION OF THE PRESENT INVENTION

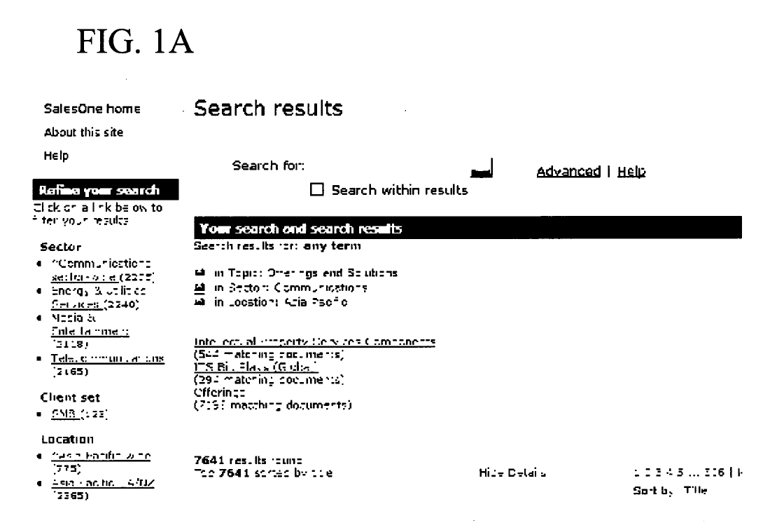

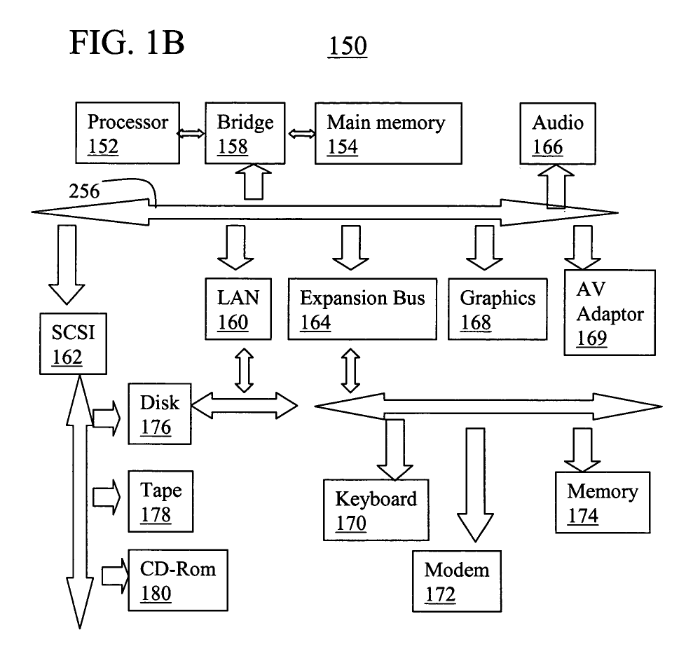

FIG. 1B illustrates one embodiment of a computer client 150 for use in accordance with one aspect of the invention. Computer system 150 is an example of a client computer, such as clients 108, 110, and 112. Computer system 150 employs a peripheral component interconnect (PCI) local bus architecture. Although the depicted example employs a PCI bus, other bus architectures such as Micro Channel and ISA may be used. PCI bridge 158 connects processor 152 and main memory 154 to PCI local bus 156. PCI bridge 158 also may include an integrated memory controller and cache memory for processor 152. Additional connections to PCI local bus 156 may be made through direct component interconnection or through add-in boards. In the depicted example, local area network (LAN) adapter 160, SCSI host bus adapter 162, and expansion bus interface 164 are connected to PCI local bus 156 by direct component connection. In contrast, audio adapter 166, graphics adapter 168, and audio/video adapter (A/V) 169 are connected to PCI local bus 156 by add-in boards inserted into expansion slots. Expansion bus interface 164 connects a keyboard and mouse adapter 170, modem 172, and additional memory 174 to bus 156. SCSI host bus adapter 162 provides a connection for hard disk drive 176, tape drive 178, and CD-ROM 180 in the depicted example. In one embodiment, the PCI local bus implementation support three or four PCI expansion slots or add-in connectors, although any number of PCI expansion slots or add-in connectors can be used to practice the invention.

An operating system runs on processor 152 to coordinate and provide control of various components within computer system 150. The operating system may be any appropriate available operating system such as Windows, Macintosh, UNIX, LINUX, or OS/2, which is available from International Business Machines Corporation. “OS/2” is a trademark of International Business Machines Corporation. Instructions for the operating system, an object-oriented operating system, and applications or programs are located on storage devices, such as hard disk drive 176 and may be loaded into main memory 154 for execution by processor 152.

Those of ordinary skill in the art will appreciate that the hardware in FIG. 1B may vary depending on the implementation. For example, other peripheral devices, such as optical disk drives and the like may be used in addition to or in place of the hardware depicted in FIG. 1B. FIG. 1B does not illustrate any architectural limitations with respect to the present invention, and rather merely discloses an exemplary system that could be used to practice the invention. For example, the processes of the present invention may be applied to multiprocessor data processing system.

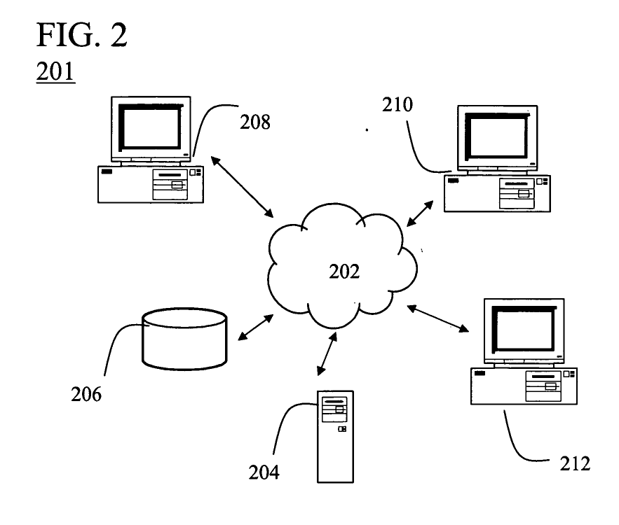

FIG. 2 illustrates an exemplary network system 201. Network system 201 is illustrative only, and is not an architectural limitation for the practice of this invention. Network system 201 is a network of computers in which the present invention may be implemented. Network system 201 includes network 202, which is the medium used to provide communications links between various devices and computers connected together within distributed network system 201. Network 202 may include permanent connections, such as wire or fiber optic cables, or temporary connections made through telephone connections. In other embodiments, network 202 includes wireless connections using any appropriate wireless communications protocol including short range wireless protocols such as a protocol pursuant to FCC Part 15, including 802.11, Bluetooth or the like, or a long range wireless protocol such as a satellite or cellular protocol.

In FIG. 2, a server 204 is connected to network 202 along with storage unit 206. In addition, clients 208, 210, and 212 also are connected to a network 202. These clients 208, 210, and 212 may be, for example, personal computers or network computers. For purposes of this application, a network computer is any computer, coupled to a network, which receives a program or other application from another computer coupled to the network. In the depicted example, server 204 provides data, such as boot files, operating system images, and applications to clients 208-212. Clients 208, 210, and 212 are clients to server 204. Network system 201 may include additional servers, clients, and other devices not shown. In the depicted example, network system 201 is the Internet with network 202 representing a worldwide collection of networks and gateways that use the TCP/IP suite of protocols to communicate with one another. Network system 201 also may be implemented as a number of different types of networks, such as for example, an intranet or a local area network.

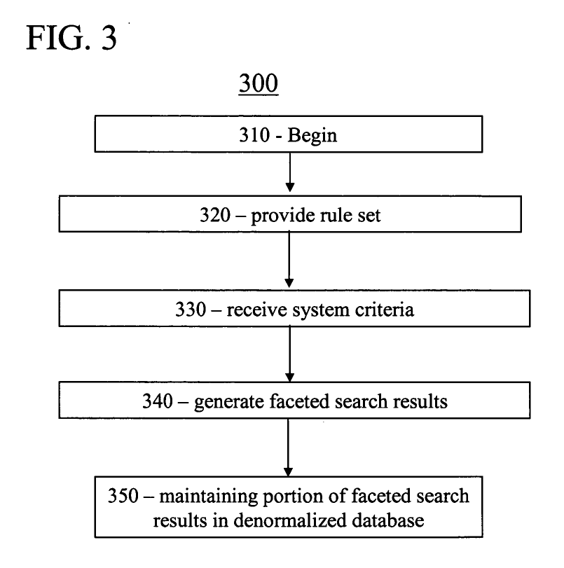

FIG. 3 illustrates one embodiment of a method 300 for caching faceted search results, in accordance with one aspect of the invention. Method 300 begins at 310.

A rule set is provided at step 320. The rule set includes at least one rule configured to affect the number of faceted search results stored in a denormalized database, in one embodiment. Other rules can be included in the rule set, such as rules configured to affect the number of discrete cache storage locations, as well as the relative size of the discrete cache locations.

In another embodiment, the rule set includes a rule configured to affect the number of records stored in the cache based on a least recently used order of operations. In another embodiment, the rule set includes a rule configured to affect the number of records stored in the cache based on a most recently used order of operations. In another embodiment, the rule set includes a rule configured to affect the number of records stored in the cache based on a first in first out order of operations. In another embodiment, the rule set includes a rule configured to affect the number of records stored in the cache based on a last in first out order of operations. In another embodiment, the rule set includes a rule configured to affect the number of records stored in the cache based on a size of the stored record.

In yet another embodiment, the rule set includes a rule configured to maintain the faceted search results based on a determined likelihood that a second faceted search will be conducted using the search terms. In such embodiments, the likelihood can be determined with any appropriate estimating algorithm. For example, a Bayesian filter can be used to estimate the likelihood. In another example, the likelihood is responsive to frequency of use or frequency of search characteristic.

Method 300 receives system criteria at step 330. In one embodiment, the system criteria are received at a server, while in other embodiments, the system criteria are received at a client in communication with a server. In one embodiment, the client is a system dedicated to tracking faceted search results, while in other embodiments, the client is implemented as a general purpose computer device.

System criteria are rules applicable to the configuration of the faceted search hardware. System criteria are based on a predetermined threshold performance time, in one embodiment. In other embodiments, system criteria are based on a predetermined maximum storage size, such as the size of memory or disk space allocated to maintaining faceted search results. In one example, a predetermined threshold performance time is determined based on a service level agreement.

Faceted search results are generated based on a first faceted search using a plurality of search terms at step 340. Generating faceted search results can be based on issuing a search request using a plurality of search terms, or by receiving the plurality of search terms. Based on the search terms, the faceted search is conducted, either by a local or remote system and the faceted search results are generated.

At least a portion of the faceted search results are maintained in a denormalized database based on the system criteria and rule set at step 350. Maintaining the denormalized database comprises creating the cache database, as well as adding and removing caching records responsive to the system criteria and rule set.

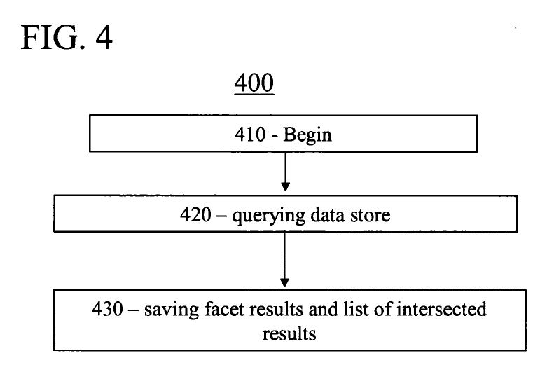

FIG. 4 illustrates one embodiment of a method 400 for conducting a faceted search based on a plurality of search terms, in accordance with one aspect of the invention Method 400 begins at 410. A data store is queried for combinations of the plurality of search terms at step 420. The data store is any database or combination of databases to be searched for search results. For example, the data store can be a data mine. In another example, the data store is a hard drive or server. In yet another example, the data store is the Internet or a portion of the Internet.

Based on the query, method 400 receives facet results generated by the query, for example, at a server, and saves the facet results in a data store. A list of intersected faceted search results are stored in a results term list. The results term list is stored at a location accessible to the server for future searches to determine possible facet matches without run time execution of the faceted search.

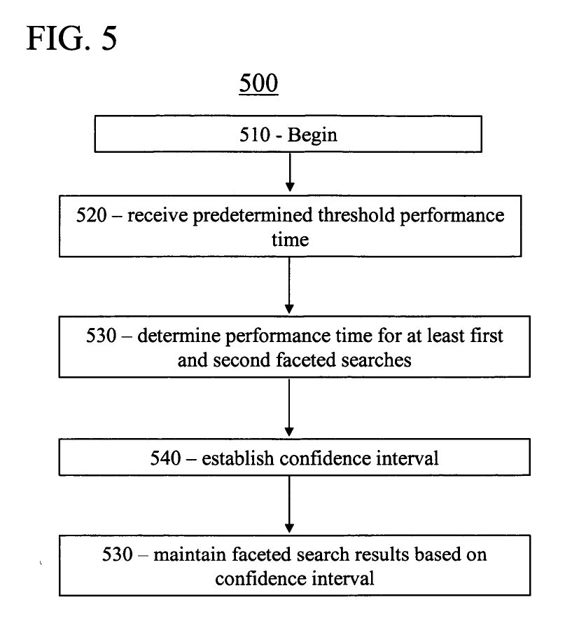

FIG. 5 illustrates one embodiment of a method 500 for caching faceted search results based on a predetermined threshold time in accordance with one aspect of the invention. Method 500 begins at 510.

The predetermined threshold performance time is received at step 520. In one example, a predetermined threshold performance time is based on a service level agreement. Thus, a particular service level agreement calls for a response time of less than 500 milliseconds, and 500 milliseconds is established as the predetermined threshold performance time.

Performance times for at least a first and second faceted search are determined based on executed searches. The executed searches can be based on run time execution of the queries or based on execution of the queries against the faceted search results cache.

A confidence interval is established based on the predetermined threshold time and the determined performance times at step 540. The confidence level measures confidence that the predetermined threshold execution time is satisfied.

A portion of the faceted search results are maintained in the denormalized database based on the confidence interval at step 550. Based on the confidence interval, the size of the denormalized database can be increased in order to reduce performance times, or decreased in order to maintain a desired performance time while reducing system load.

For example, a denormalized facet relational index stores facet counts generated by faceted searches in a cached structure to be accessed without a run time execution of a search query against the data store. The size of the cached structure is maintained based on a rule set and system criteria including specific factors. These factors include, but are not limited to, likelihood that a request for a particular combination of facet elements will be made, the recency with which a given combination has been requested, and the amount of content for a given facet combination. A term list representation can be generated to provide storage and access to the facet counts, as well as documents or data resulting from a given facet set intersection calculation Thus, existing term list representations of faceted structures are used to generate, store, and return new term list representations of faceted structures.

For example, a system is provided three facet elements A-1, B-17, and C-3, each belonging to three independent facet trees. The system determines that A-1 is a root facet element, B-17 is two levels from the root of facet B, and C-3 is a child of the root node of facet set C. This set intersection will generate a set of stored facet count data as well as a new term list representation of the combined A-1/B-17/C-3 set.

In one embodiment, multiple versions of the cache structure are maintained to store faceted search results using a plurality of rules and or system criteria. In such an embodiment, each cache structure can be queried for faceted search results prior to a run time execution of faceted search terms. Performance times for queries executed against each cache structure can then be tracked, and rule sets or system criteria adjusted to improve system performance by keeping performance times within an acceptable range while reducing the required storage space. Additionally, multiple versions of the cached structure can be generated prior to presenting the faceted search results to a user or program.

In one embodiment, faceted search results based on a first faceted search are maintained in a first denormalized database. A second faceted search using dependent set intersections is then executed against the first denormalized database rather than the data store.

In yet another embodiment, faceted search results are stored in a relational database, rather than a denormalized database. Relational database storage of faceted search results can be based on any appropriate relational database technique, including, but not limited to, single row per facet as well as a parent-child format. Any of the methods disclosed herein can be implemented using a relational database storage mechanism.

It should be noted that both the server and devices can reside behind a firewall, or on a protected node of a private network or LAN connected to a public network such as the Internet. Alternatively, the server and devices can be on opposite sides of a firewall, or connected with a public network such as the Internet. The invention can take the form of an entirely hardware embodiment, an entirely software embodiment, or an embodiment containing both hardware and software elements. In a preferred embodiment, the invention is implemented in software, which includes but is not limited to firmware, resident software, microcode, etc. Furthermore, the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device. The medium can be an electronic, magnetic, optical, electromagnetic, infrared, or semiconductor system (or apparatus or device), or a propagation medium such as a carrier wave. Examples of a computer-readable medium include a semiconductor or solid state memory, magnetic tape, a removable computer diskette, a random access memory (RAM), a read-only memory (ROM), a rigid magnetic disk and an optical disk.

While the embodiments of the present invention disclosed herein are presently considered to be preferred embodiments, various changes and modifications can be made without departing from the spirit and scope of the present invention. The scope of the invention is indicated in the appended claims, and all changes that come within the meaning and range of equivalents are intended to be embraced therein.

We claim:

1. A method of caching faceted search results, the method comprising:
providing a rule set;
receiving system criteria;
generating at least one faceted search result based on a first faceted search using a plurality of search terms; and
maintaining at least a portion of the faceted search results in a denormalized database based on the rule set and system criteria.

2. The method of claim 1 wherein the rule set includes at least one rule configured to affect the number of faceted search results stored in the denormalized database.

3. The method of claim 2 wherein the rule set includes at least one rule selected from the group consisting of least recently used, most recently used, first in first out, last in first out, least used, most used, and size of record.

4. The method of claim 2, wherein the rule set includes at least one rule to store the faceted search results based on a determined likelihood that a second faceted search will be conducted using the search terms.

5. The method of claim 1 wherein conducting a faceted search based on a plurality of search terms comprises querying a data store for combinations of the plurality of search terms and saving the facet results generated by the query in a data store and saving a list of intersected faceted search results as a results term list.

6. The method of claim 1 wherein the system criteria are based on a predetermined threshold performance time.

7. The method of claim 6 further comprising:
receiving the predetermined threshold performance time;
determining performance time for at least the first faceted search and a second faceted search;
establishing a confidence interval based on the determined performance time and predetermined threshold performance time; and
maintaining the portion of the faceted search results based on the established confidence interval.

8. The method of claim 7 wherein the predetermined threshold performance time is based on a service level agreement.

9. A computer readable medium including computer readable code for caching faceted search results, the medium comprising:
computer readable code for providing a rule set;
computer readable code for receiving system criteria;
computer readable code for generating at least one faceted search result based on a first faceted search using a plurality of search terms; and
computer readable code for maintaining at least a portion of the faceted search results in a denormalized database based on the rule set and system criteria.

10. The medium of claim 9 wherein the rule set includes at least one rule configured to affect the number of faceted search results stored in the denormalized database.

11. The medium of claim 10 wherein the rule set includes at least one rule selected from the group consisting of least recently used, most recently used, first in first out, last in first out, least used, most used, and size of record.

12. The medium of claim 10, wherein computer readable code for conducting a faceted search includes at least one rule to store the faceted search results based on a determined likelihood that a second faceted search will be conducted using the search terms.

13. The medium of claim 9 wherein computer readable code for conducting a faceted search based on a plurality of search terms comprises computer readable code for querying a data store for combinations of the plurality of search terms and computer readable code for saving the facet results generated by the query in a data store and computer readable code for saving a list of intersected faceted search results as a results term list.

14. The medium of claim 9 wherein the system criteria are based on a predetermined threshold performance time.

15. The method of claim 14 further comprising:
computer readable code for receiving the predetermined threshold performance time;
computer readable code for determining performance time for at least the first faceted search and a second faceted search;
computer readable code for establishing a confidence interval based on the determined performance time and predetermined threshold performance time; and
computer readable code for maintaining the portion of the faceted search results based on the established confidence interval.

16. A system for caching faceted search results, the system comprising:
means for providing a rule set;
means for receiving system criteria;
means for generating at least one faceted search result based on a first faceted search using a plurality of search terms; and
means for maintaining at least a portion of the faceted search results in a denormalized database based on the rule set and system criteria.
